(19) United States
(12) Patent Application Publication
(10) Pub. No.: US 2009/0164477 A1
(43) Pub. Date: Jun. 25, 2009

(54) METHOD OF ELECTRONIC SALES LEAD VERIFICATION

(76) Inventor: Anik Ganguly, Plymouth, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/341,889

(22) Filed: Dec. 22, 2008

Related U.S. Application Data
(60) Provisional application No. 61/015,482, filed on Dec. 20, 2007.

(51) Int. Cl. G06F 7/06; G06F 17/30; G06F 17/00

(52) U.S. Cl. 707/10; 715/222; 707/E17.107

(57) ABSTRACT

A method and system are disclosed that enable a party to verify that a specific web-form was the source of the information by comparing the information captured by a verification-agent with the information the agent receives directly or indirectly from the party hosting tie web-form. In one embodiment, the method for verifying data may comprise providing a computer server having a processor and a computer readable memory. The server may receive a first tracked data set and then store that data set for later reference. The server may then receive a verification request and compare tie data from that request against the stored tracked data. After a comparison as been made, the server may then transmit a verification response that indicates the results of the comparison.

### CROSS-REFERENCE TO RELATED APPLICATIONS

This Application is a Non-Prov of Prov (35 USC 119(e)) application 61/015,482 filed on Dec. 20, 2007, the disclosure of which is incorporated herein by reference.

### FIELD OF THE INVENTION

A method and system is disclosed for verifying the origin of remotely prepared data. The method and system may include obtaining tracking data that is specific to a remotely prepared electronic form and also applying an electronic seal to that form. The method and system allow for the origin of a specific prepared form to be tracked so that a purchaser of the data associated with the prepared form may have increased confidence in the legitimacy of that data.

### BACKGROUND OF THE INVENTION

The collection and sale of business leads (i.e., the contact, personal, financial and business data, etc., for a person who may be interested in purchasing a particular product or service) is a fast-growing and potentially lucrative industry. For example, it is not unusual for a single lead to be traded or sold at a price exceeding $20 depending upon: 1) the product or service that is being offered by the purchaser of lead information (e.g., appliances, vehicles, vehicle financing, lawn services, etc.); and 2) a lead's geographic location. Therefore, entities involved in the collection and sale of leads will often go to great lengths to obtain (or generate) new lead information for purposes of sale.

One method by which sales lead information may be collected is through Internet websites. A lead generator may set up one or more websites (or arrange to collect data from a third-party website) with a goal of eliciting new sales lead information from the otherwise anonymous visitors to those sites. For example, a lead generator may establish and promote a website that provides product reviews for new kitchen appliances. Then, once on the site, a visitor may be presented with one or more audio/visual cues that prompt and permit the user to submit information (e.g., name, address, phone number(s), social security numbers, etc.). These audio/visual cues come in a variety of forms, including offers for low-cost appliance financing and offers to have a local retail appliance retailer contact the visitor to discuss a potential purchase.

When a particular website(s) is established and operated by a reputable lead generator, there is a reasonable likelihood that the information submitted by a visitor and sold by the generator will be legitimate. However, given the significant potential for economic gain resulting from the sale of leads, it is often the case that information is collected by dishonest lead generators. A dishonest lead generator may have obtained information using “a bait-and-switch approach” in which a website visitor is fraudulently enticed to submit information in return for a existent or likely non-existent incentive or prize (e.g., a free Apple iPod). A further problem resulting from the bait-and-switch is that a purchaser of the ill-gotten sales lead information will have paid good money for potentially accurate sales lead information, only to find out that the person associated with the lead (the website visitor) was only interested in obtaining a prize and actually had no interest in the lead purchaser's product or service.

Therefore, it would be advantageous to have a system and/or method in place that allows tie origin of data (such as a sales lead) be tracked and verified.

### SUMMARY OF THE INVENTION

Disclosed is an embodiment for a method and system for verifying the source of information transmitted on the World-wide Web (Web, Internet). In tie method or system, a remote computer user or consumer may submit information from their web-browser (or the like), computer or device using data collection forms expressed in a markup language such as HTML, XML or the like (Web-forms). In tie process of displaying the forms a server (Verification-agent) may receive and log the time, IP-address of the user's computer, the URL of the form, tie URL parameters and information in the HTTP request.

The information supplied by the user may then be collected by the party hosting the Web-form and subsequently transmitted to another party (a Receiving-party). The IP address of the user's computer or device may be supplied as additional credentials along with a unique identifier and with the other information submitted by the user. This other information may include sales lead information. A sales lead is an expression of interest in a product or service by a user who supplies his/her contact information and requests follow up.

The method and system disclosed herein enables the Receiving-party to verify that a specific Web-form was the source of the information by comparing the information captured or collected by the Verification-agent with the information it receives directly or indirectly from the party hosting the Web-form.

### BRIEF DESCRIPTION OF THE DRAWING

FIG. 1 is a diagrammatic view of an embodiment of a method and system of electronic sales lead verification.

### DETAILED DESCRIPTION OF THE PREFERRED EMBODIMENTS

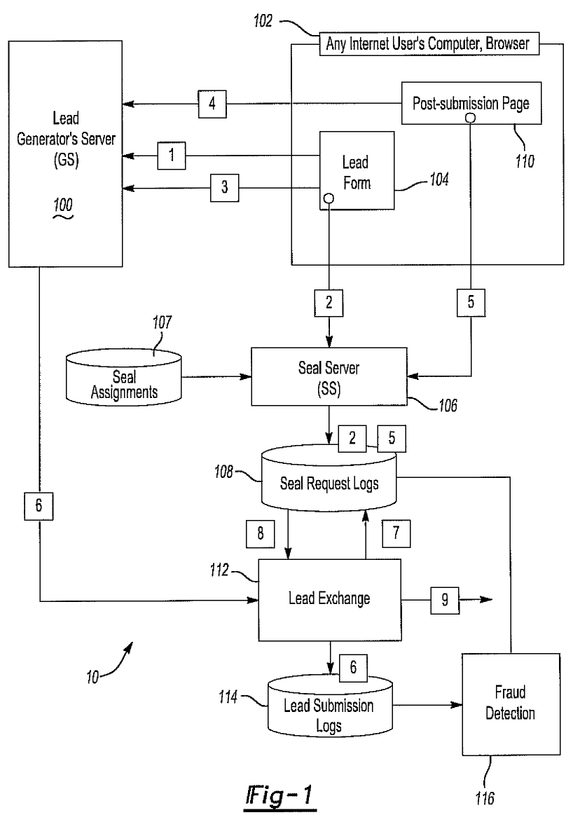

Referring to FIG. 1, there is disclosed an embodiment of a method and system for electronic sales lead verification. In the embodiment, a provider (not shown) of data (e.g., a person surfing the internet) may visit a website associated with a data generator (e.g., a sales lead generator—not shown) and be presented with an electronic form to prepare and submit. It will be appreciated that the website, and the associated electronic form data, may be resident on a computer server 100 that is owned, operated, controlled or accessible by the data generator. It will also be appreciated that as consequence of visiting the website, the site will be presented to the provider by virtue of being loaded onto, or being made viewable in, a browser or viewer program (e.g., MS Internet Explorer, Opera, Firefox, Safari, etc.) resident on the provider's computer 102 or like device.

Still referring to FIG. 1, the provider may select a link (1) on a website (or the like) that causes an electronic lead form 104 to load into the browser or viewer on the computer 102 or device. For example, the provider may “click on” or select a “click to request a customized quotation from a dealer near you link/button” found on a data generator's website. Thereafter, form data for the electronic lead form 104 page, including a unique identifier for the form, may be transmitted from the data generator's server 100 to the provider's computer 102 and then displayed by internet browser or viewer. The unique identifier transmitted with the form data may be a computer code (e.g., html), a digital image, or other electronic tag that is provided in advance to the data generator server 100 by the seal server 106 (discussed below) and then associated with a specific type of electronic lead form 104.

Still referring to FIG. 1, a computer code (e.g., html) associated with the form data/electronic lead form 104 may contain a script (or similar electronic prompt) to cause a query to be transmitted (2) from the provider's browser/computer 102 to a remotely located seal server 106, processing unit or like device. Specifically, as the form data/electronic lead form 104 is automatically loaded onto the provider's device/computer 102 by the browser (or concurrently therewith), the form data/electronic lead form 104 (specifically, the code therefore) may prompt the provider's device or browser to transmit a first query or tracked data set to a remote seal server 106. Tie first query or tracked data may include: 1) a time and date log corresponding to the transmission time of the query (or alternatively the generation of the form on the browser); 2) the IP-address of the provider's computer 102 or device; 3) the URL of the form being prepared (i.e., the a referrer url); 4) the URL parameters and information in the HTTP request; and 5) the unique identifier associated with the form data. The seal server may include a seal assignment database 107 that includes a collection of unique electronic data seals or identifiers in the form of a graphic image, and a seal request data log 108 (i.e., a computer readable memory).

Still referring to FIG. 1, the seal server 106 may record or log the first query or tracked data set received from the provider's computer 102 and/or browser into the seal request log 108 for use in later verification steps. It will, for example, be appreciated that since the first query originated from the provider's browser or computer 102 (rather than of a data generator server's), tie data associated with that query may be used to confirm that the initial request for the electronic lead form 104 came from the provider's computer/browser 102. After the first query is received, the server 106 may obtain a seal page (not shown) from the seal assignment database 107 that may then be transmitted back to the provider's browser 102 for incorporation into the electronic lead form 104. The seal page, for example, may appear as an image of a golden seal on electronic lead form 104.

Still referring to FIG. 1, once prepared, the electronic lead form 104 may be submitted/electronically returned (3) to the lead generator's server 100 from the provider's browser/computer 102 as a prepared electronic form. Then, as an optional step, upon submission of the electronic lead form 104 to the lead generator's server 100, the provider's internet browser 102 or device may be automatically redirected (4) to a post-submission webpage 110 that is likewise displayed on the provider's device using a computer code associated with tie form data/electronic lead form.

Still referring to FIG. 1, like the electronic lead form 104, the form data for the post-submission page 110 may be transmitted to the provider's computer 102 or device from the data generator's server 100 (or, alternatively, another location). A computer code (e.g., html) may also associated with the post-submission page 110 that directs a second query or second tracked data set to be transmitted (5) from the provider's browser/computer 102 to the seal server 106. It will also be appreciated that the second query or tracked data set may contain the same type of data that is associated with the first query.

The seal server 106 may log the second query, similar to the first query, and transmit a seal for the post-submission page back to the provider's browser/computer 102. However, in logging the second query, the second query will be associated or link with the first query based, for example, on a comparison of the unique identifiers transmitted with the first and second queries, the I.P. address of the provider's computer as indicated in the queries, or like data. Notably, the unique identifiers used in the forms, pages and queries may be represented by two different sets of computer code that are each associated with a particular form (104) or page (110), and that are also specifically paired to one another. This pairing of the unique identifiers will, of course, be advantageous for purposes of later verification of form data.

Still referring to FIG. 1, in operation the method and system may include at least two separate instances of a query or tracked data being logged into a data log 108 on the server 106. It may also be appreciated that each logged query may be generated as a result of actions taken solely by tie intended provider of the data (i.e., the website visitor) and transmitted directly from the provider's browser/computer 102. Accordingly, the data lead generator's server 100, and thus the data generator, is removed from the process of verifying that a provider actually visited the data generator's website or that the provider independently chose to submit data.

Still referring to FIG. 1, the electronic lead form 104 may be prepared and submitted to the data server 100 from the provider's browser, computer 102 or device and include collected data 1) concerning the provider, and 2) a copy of tie first query or tracking data. The collected or prepared data concerning the provider may include personal, business information and financial information for the provider. Then, following receipt, the data generator server 100 may forward (6) the collected data to a (lead) trading exchange 112, the seal server 106 or a similar apparatus. It will also be appreciated that the trading exchange 112 and seal server 106 may consist of a single server or processing device or unit, two or more servers or processing devices or units, or as part of a single computer system that includes separate processors for the exchange 112 and the server 106.

Still referring to FIG. 1, the lead exchange 112 (or the seal server 106 itself) may record the collected data received from the data generator's server 100 a (lead) submission log 114. Thereafter, the exchange 112 (or tie seal server 106) will command or transmit (as necessary) a verification request or query (7).

In response the verification request, the exchange 112 (or the seal server 106) may compare collected data from the data generator's server 100 (e.g., tie sales lead information), against the first query (generated by the electronic lead form) and, if present, the second query (generated by the post-submission page) to determine if a links exist between the data. This comparison may, for example, review the data to determine if the collected data and the first query data include the same I.P. address, or the same unique identifier, or the same time or date stamps. Additionally, or alternatively, the collected data, first and second query data could be reviewed to confirm that the collected data, and first and second query data share the same I.P. address, and if tie first and second query data share associated unique identifiers.

If a link can be established (8) between the collected data in the collected data of the submission log 114, the collected data may be certified though the generation and transmission by the lead exchange 112 or seal server 106 of a notice that includes a source verification attestation (e.g., a Yes). Alternatively where a link cannot be established, made (9) the data may not be certified and may include an alert (i.e., a No) that the source cannot be verified.

In addition, asynchronous fraud detection systems 116 will scan the inquiry or tracked data contents of the seal request log 108 and, if necessarily, the lead submission log 114 for particular patterns that suggest fraudulent activity. Where, for example, the fraud detection systems 116 determine that an electronic lead form 104 was completed and submitted by the provider's computer 102 in less than a predetermined period of time (e.g., less than three seconds, or more preferably in a range of 1 to 10 seconds), then the system 116 may conclude that the form was fraudulently prepared and filed by an automated system. If such patterns are detected the situation may be reported to the appropriate authorities.

Having thus described the invention, various other embodiments for a method of electronic sales lead verification may become apparent to those of skill in the art that do not depart from the spirit of the present embodiment.

I claim:

1. A method for verifying data, comprising:
providing a computer server having a processor and a computer readable memory;
receiving by the server a first tracked data set;
storing the first tracked data set in the computer readable memory;
receiving by the server a verification request;
comparing by the server the verification request against the tracked data stored in the computer readable memory; and
transmitting by the server a verification response.

2. The method of claim 1 comprising:
receiving by the server a second tracked data set after the first tracked data set; and
storing the second tracked data set in the computer readable memory and associating the second tracked data set with the first tracked data set.

3. The method of claim 2 wherein the first tracked data set includes a first time stamp, the second tracked data set includes a second time stamp, and the verification response includes a notice when the difference between the first and second time stamps is less than a predetermined period of time.

4. The method of claim 3 wherein the predetermined period of time is in a range from 1 to 10 seconds.

5. The method of claim 2 comprising:
generating by the server a notice in response to the comparison of the verification request against the tracked data, the notice indicating whether a correlation exists between the first tracked data set, the second tracked data set and the third data set; and
the verification response including the notice.

6. The method of claim 1 wherein the server comprises a database including a set of unique identifiers.

7. The method of claim 1 wherein the first tracked data set includes at least one data set selected from a group consisting of: an internet protocol address for a device, a data set indicating the date and time the first tracked data set was transmitted by a device, a referrer url, and a unique identifier.

8. The method of claim 1 wherein the first tracked data set comprises a unique identifier.

9. The method of claim 1 comprising transmitting by the server a confirmation data set in response to the receipt of the first tracked data set.

10. The method of claim 9 wherein the confirmation data set comprises a graphic image.

11. The method of claim 1 wherein the verification request comprises data selected from the first tracked data set.

12. A method for verifying data, comprising:
providing a first and a second computer processing unit, each unit having a computer processor and the first unit having a computer readable memory;
receiving by the first unit a first tracked data set;
storing the first tracked data set in the computer readable memory;
receiving by the first unit a second tracked data set;
storing the second tracked data set in the computer readable memory, and associating the second tracked data set with the first tracked data set;
receiving on the second unit a collected data set;
comparing by one of the first or the second unit of the collected data set against the tracked data stored in the computer readable memory; and
transmitting by one of the first or the second unit a verification response.

13. The method of claim 12 wherein the collected data set comprises data selected from the first tracked data set.

14. The method of claim 12 wherein the collected data comprises a business lead.

15. The method of claim 12 wherein the second unit comprises a computer readable memory and the collected data set is stored in the computer readable memory of the second unit.

16. The method of claim 12 wherein the first tracked data set includes at least one data set selected from a group consisting of: an internet protocol address for a device, a data set indicating the date and time the first tracked data set was transmitted by a device, a referrer url, and a unique identifier.

17. The method of claim 12 wherein the first tracked data set and the collected data set comprise substantially the same data.

18. The method of claim 12 wherein the collected data set comprises a unique identifier.

19. The method of claim 12 wherein the first and second unit are part of a single computer system.

20. A method for verifying data, comprising:
receiving a unique identifier;
providing a computer server having a processor;
providing on the server electronic form data including the unique identifier, the form data operating to generate an electronic form on a remote computer device and cause a remote device to transmit a first tracked data set;
transmitting by the server the electronic form data;
receiving by the server prepared electronic form data including the unique identifier and an internet protocol address for a device at the remote location.
